(19) United States
(12) Patent Application Publication
(10) Pub. No.: US 2008/0065756 A1
(43) Pub. Date: Mar. 13, 2008

(54) Method and system for presenting network devices on a display screen of a network management system

(76) Inventors: Frances Jean Hardwick, Ottawa (CA); Pascal Harnois, Ottawa (CA); Sasa Nijemcevic, Nepean (CA); David Kiesekamp, Merrickville (CA); Terrence Martineau, Ottawa (CA)

Correspondence Address: KRAMER & AMADO, P.C., 1725 DUKE STREET, SUITE 240, ALEXANDRIA, VA, 22314, US

(21) Appl. No.: 11/517,341

(22) Filed: Sep. 8, 2006

(51) Int. Cl. G06F 15/173; G06F 15/177

(52) U.S. Cl. 709/224; 709/223; 715/734

(57) ABSTRACT

A method for presenting network devices associated with a communications network on a display screen of a network management system, comprising: displaying a first list of the network devices on the display screen; receiving a signal from a user to select a network device from the first list, the network device having associated therewith one or more items; generating a second list of the one or more items; and, displaying the second list on the display screen to thereby improve access to the one or more items by the user.

### FIELD OF THE INVENTION

This invention relates to the field of network management, and more specifically, to a method and system for presenting network devices in a communications network on a display screen of a network management system.

### BACKGROUND OF THE INVENTION

The telecommunications management network (“TMN”) provides a framework for achieving interconnectivity and communication across heterogeneous operating systems and telecommunications networks. TMN is defined in the International Telecommunications Union (“ITU”) Telecommunications Services Sector (“ITU-T”) M.3000 recommendation series (which are incorporated herein by reference). When telecommunications networks implement the TMN definitions, they become interoperable, even when interacting with the networks and equipment of other telecommunications service providers.

TMN uses object-oriented principles and standard interfaces to define communication between management entities in a network. TMN architecture and interfaces, defined in the ITU M.3000 recommendation series, build on existing open systems interconnection (“OSI”) standards (which are incorporated herein by reference). These standards include the Common Management Information Protocol (“CMIP”) which is a network monitoring and control standard which defines management services exchanged between peer entities. Other standards include the Guideline for Definition of Managed Objects (“GDMO”) which provides templates for classifying and describing managed resources, the Abstract Syntax Notation 1 (“ASN.1”) which provides syntax rules for data types, and the Open Systems Interconnect Reference Model which defines the seven-layer OSI reference model. (All of the preceding standards and protocols are incorporated herein by reference.)

Thus, TMN is based on the OSI management framework and uses an object-oriented approach, with managed information in network resources modeled as attributes in managed objects. Management functions are performed by operations comprised of Common Management Information Service (“CMIS”) primitives. A network's managed information, as well as the rules by which that information is presented and managed, is referred to as the Management Information Base (“MIB”). Processes that manage the information are called “management entities”. A management entity can take on one of two possible roles: “manager” or “agent”. Manager and agent processes send and receive requests and notifications using the CMIP.

A central concept to understanding the operation of TMN is found in the area of object-oriented systems. The OSI Management Information Structure (frequently referred to as the Structure of Managed Information (“SMI”)) is based on collections of objects, some defined in the ISO X.720 series of standards (which are incorporated herein by reference), others that can be found in the TMN M.3100 standards, along with application specific objects that describe the behaviour and offer control points for the specific managed systems. CMIP based MIBs are a collection of managed objects that contain attributes, exhibit some behaviours, can be created and deleted, and may optionally provide application specific actions that a manager can request. Each object can be viewed as possessing a certain set of behaviours, attributes, and actions. The behaviour of an object is directly related to the resource that it represents. For example, a termination point may exhibit the behaviours associated with its relationship with other system components. Attributes contained in an object describe the state and condition of the objects behaviour. Continuing with the termination point as an example, attributes can include references to other objects with which the termination point interacts such as a trail. Actions are services that the object can provide at the request of the management system. The templates for an object's behaviour are defined with GDMO and ASN.1 for TMN. As objects are identified by the management system agent or manager, objects are instantiated (another term for created). Each class of objects defined in the MIB can be instantiated as many times as the equipment and environment warrant.

Similar to CMIP, the Common Object Request Broker Architecture (“CORBA”), which is incorporated herein by reference, is an open distributed object infrastructure defined by the Object Management Group (“OMG”). OMG is an industrial consortium that, among other things, oversees the development and evolution of CORBA standards and their related service standards through a formal adoption process. CORBA standardizes and automates many common network programming tasks such as object implementation, registration, and location transparency. CORBA also defines standard language mappings of most popular languages for the programming interfaces to services provided by the Object Request Broker (“ORB”). An ORB is the basic mechanism by which objects transparently make requests to and receive responses from other objects on the same machine or across a network.

Now, a modem communications network (e.g., an Internet Protocol (“IP”) based network) may include a number of network devices or nodes (e.g., routers, switches, etc.) represented by managed objects. The network devices may be provided by a number of different manufacturers. In addition, the communications network may have a number of Network Management Systems (“NMS”) for configuring (and provisioning, controlling, monitoring, etc.) the network devices. For example, the communications network may have first and second NMSs for first and second groups of network devices provided by first and second manufacturers, respectively. In turn, each NMS may be configured by one or more Operations Support Systems (“OSS”). Typically, an OSS is operated by a telecommunications service provider such as a local telephone company. Each OSS may be CMIP based or CORBA based. In such a system, each NMS will typically have an interface (“OSSI”) for each protocol (i.e., CMIP, CORBA, etc.) used by its related OSSs. Thus, the CMIP/CORBA OSSI is a standardized interface for use by network operators or service providers to provision the devices in their networks. The OSSI specifies the use of standardized object models to perform provisioning of corresponding network devices.

However, one problem with current MNSs is the inability of their graphical user interfaces (“GUIs”) to effectively present the network devices comprising a communications network to users. This is especially so for communications networks that include high numbers (e.g., hundreds, thousands, etc.) of network devices such as routers, switches, etc. Typically, a NMS displays network devices that it manages via a navigation tree display. Such a navigation tree display, for example, may display up to 2000 network devices which may be organized into groups of 20-30 devices. Each device displayed in the navigation tree may also be expanded to display all the items which they contain (e.g., shelves, cards, ports etc.). As such, the content of a single expanded network device may take up most of the viewing area in a window for the navigation tree. This can result in extremely long trees even if the network has only 5-10 routers. In order to find or monitor a device, the user or operator of the NMS is required to frequently scroll to view all the devices of interest in the network. If the user wants to view information pertaining to a different device, the user must then scroll back up the hierarchy of the tree and select the new device and expand it. This can be very time consuming. Thus, to view devices in large navigation trees users must continuously expand and collapse devices (or objects, items, containers, etc.) and/or scroll to desired locations within the tree. In particular, while users may wish to frequently monitor specific devices in the network, these devices are not all viewable at one time in the same tree display. In addition, while users may need to repeatedly access specific devices, searching through the device hierarchy in a navigation tree display can be very time consuming especially when the tree display contains thousands of devices.

A need therefore exists for an improved method and system for presenting network devices in a communications network on a display screen of a network management system. Accordingly, a solution that addresses, at least in part, the above and other shortcomings is desired.

### SUMMARY OF THE INVENTION

According to one aspect of the invention, there is provided a method for presenting network devices associated with a communications network on a display screen of a network management system, comprising: displaying a first list of the network devices on the display screen; receiving a signal from a user to select a network device from the first list, the network device having associated therewith one or more items; generating a second list of the one or more items; and, displaying the second list on the display screen to thereby improve access to the one or more items by the user.

The method may further include displaying the first and second lists as first and second navigation trees, respectively. A first item in the first navigation tree may be a first root representing the communications network and a first item in the second navigation tree may be a second root representing the network device. The method may further include displaying the first and second lists in first and second windows, respectively. The method may further include receiving a signal from the user to replace the first list with the second list on the display screen. The method may further include receiving a signal from the user to replace the second list with the first list on the display screen. The method may further include receiving a signal from the user to display both the first and second lists on the display screen. The network device may be an item within the network device. And, the one or more items may be one or more of shelves, card slots, daughter cards, and ports.

In accordance with further aspects of the present invention there is provided an apparatus such as a data processing system (e.g., a network management system (“NMS”), a network device, etc.), a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a communications network adapted to implement an embodiment of the invention;

FIG. 2 is a block diagram illustrating a data processing system adapted to implement an embodiment of the invention;

FIG. 3 is a screen capture illustrating a navigation tree for a communications network;

FIG. 4 is a screen capture illustrating the navigation tree of FIG. 3 expanded for a network device represented in the tree;

FIG. 5 is a screen capture illustrating a pop-up menu for generating a new navigation tree from an original navigation tree in accordance with an embodiment of the invention;

FIG. 6 is a screen capture illustrating a new navigation tree in accordance with an embodiment of the invention; and,

FIG. 7 is a flow chart illustrating operations of modules within the memory of a data processing system for presenting network devices associated with a communications network on a display screen of the data processing system, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and techniques have not been described or shown in detail in order not to obscure the invention. The term “data processing system” is used herein to refer to any machine for processing data, including the network management systems and network devices described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware.

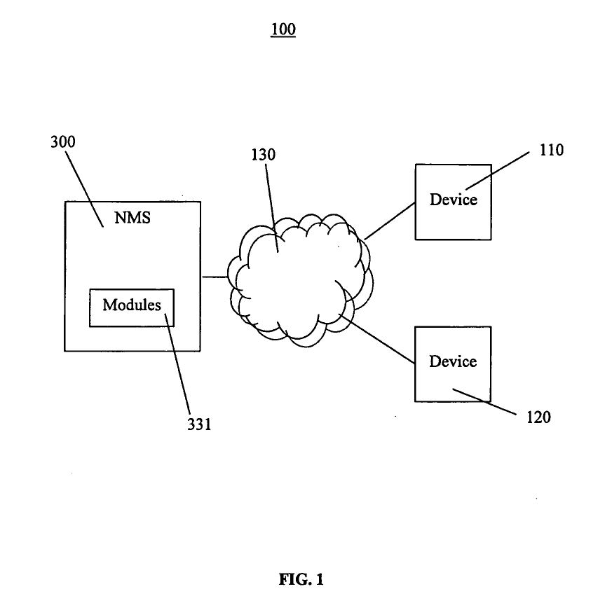

FIG. 1 is a block diagram illustrating a communications network 100 adapted to implement an embodiment of the invention. The communications network 100 includes a network management system (“NMS”) 300 coupled to one or more network devices or nodes 110, 120 over a network 130 (e.g., an Internet Protocol (“IP”) network). The network devices 110, 120 may be routers, switches, etc. The NMS 300 and network devices 110, 120 may be maintained by a service provider (“SP”) to provide services to subscribers (not shown). The NMS 300 configures, controls, and monitors the network devices 110, 120 coupled to it. The NMS 300 may be located at the SP's central office (“CO”), co-located with a network device, or located elsewhere.

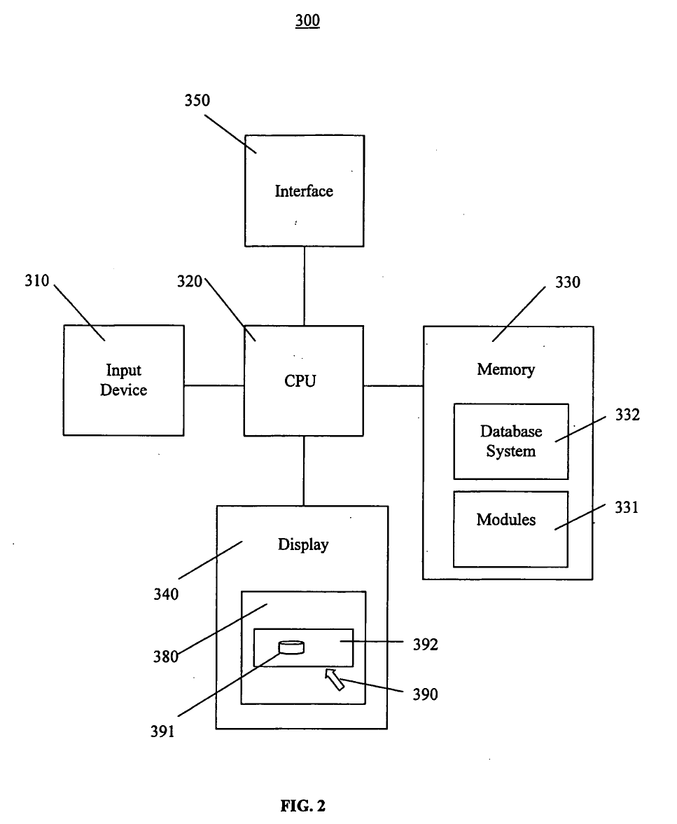

FIG. 2 is a block diagram illustrating a data processing system 300 adapted to implement an embodiment of the invention. The data processing system 300 may be a server system or a personal computer (“PC”) system and is suitable for operation as or with a NMS 300 or network device 110, 120. The data processing system 300 includes a central processing unit (“CPU”) 320, memory 330, and an interface device 350 and may optionally include an input device 310 and a display 340. The CPU 320 may include dedicated coprocessors and memory devices. The CPU 320 is operatively coupled to memory 330 which stores an operating system (not shown) for general management of the system 300. The memory 330 may include RAM, ROM, disk devices, and databases. The memory 330 may include a variety of storage devices including internal memory and external mass storage typically arranged in a hierarchy of storage as understood to those skilled in the art. The interface device 350 may include a network connection. The data processing system 300 is adapted for communicating with other data processing systems (e.g., 110 or 120) over a network 130 via the interface device 350. The input device 310 may include a keyboard, a mouse, a trackball, or a similar device. And, the display 340 may include a computer screen, terminal device, or a hardcopy producing output device such as a printer or plotter. The CPU 320 of the system 300 is typically coupled to one or more input devices 310 for receiving user commands or queries and for displaying the results of these commands or queries to the user on the display 340. The data processing system 300 may include a database system 332 for storing and accessing network topology and programming information. The database system 332 may include a database management system (“DBMS”) and a database and may be stored in the memory 330 of the data processing system 300. The data processing system 300 has stored therein data representing sequences of instructions which when executed cause the method described herein to be performed. Of course, the data processing system 300 may contain additional software and hardware a description of which is not necessary for understanding the invention.

A user may interact with the data processing system 300 and its hardware and software modules 331 using an optional graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input or pointing device such as a mouse 310. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input or pointing device (e.g., a mouse) 310 to position a pointer or cursor 390 over an object (e.g., an icon) 391 and by “clicking” on the object 391.

Typically, a GUI based system presents application, system status, and other information to the user in “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

Thus, the data processing system 300 includes computer executable programmed instructions for directing the system 300 to implement the embodiments of the present invention. The programmed instructions may be embodied in one or more hardware modules or software modules 331 resident in the memory 330 of the data processing system 300. Alternatively, the programmed instructions may be embodied on a computer readable medium (such as a CD disk or floppy disk) which may be used for transporting the programmed instructions to the memory 330 of the data processing system 300. Alternatively, the programmed instructions may be embedded in a computer-readable signal or signal-bearing medium that is uploaded to a network by a vendor or supplier of the programmed instructions, and this signal or signal-bearing medium may be downloaded through an interface (e.g., 350) to the data processing system 300 from the network by end users or potential buyers.

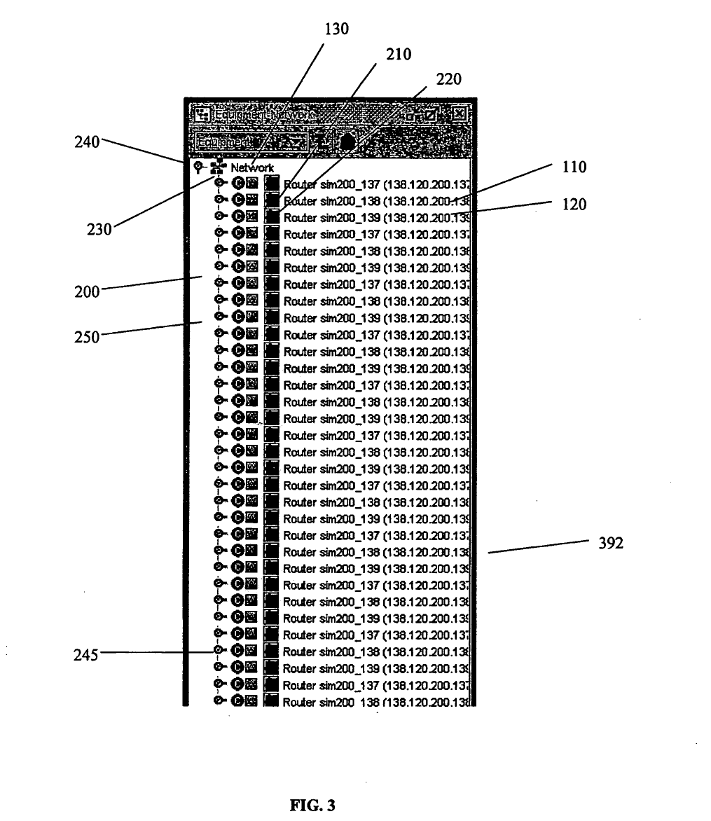

FIG. 3 is a screen capture illustrating a navigation tree 200 for a communications network 100, 130. The navigation tree 200 is displayed in a window 392 of the GUI 380 of the NMS 300. The navigation tree 200 has a network icon 230 (and optional corresponding name) which represents the network 100, 130. The network icon 230 is the “root” of the navigation tree 200 of FIG. 2. To view a representation of the devices 110, 120 within the network 100, 130, the user may click on an expand/collapse icon 240 adjacent to the network icon 230. Upon clicking on the expand/collapse icon 240, a list 250 of item icons 210, 220 (and optional corresponding names) representing devices 110, 120 in the network 130 is displayed. That is, the network icon 230 is “expanded” to show a list 250 of items 210, 220 associated with it. Upon clicking on the expand/collapse icon 240 subsequently, the list 250 is removed from the display. That is, the list 250 of items 210, 220 is “collapsed”. The expand/collapse icon 240 may change shape (e.g., 245) to indicate whether an expand or collapse operation is available.

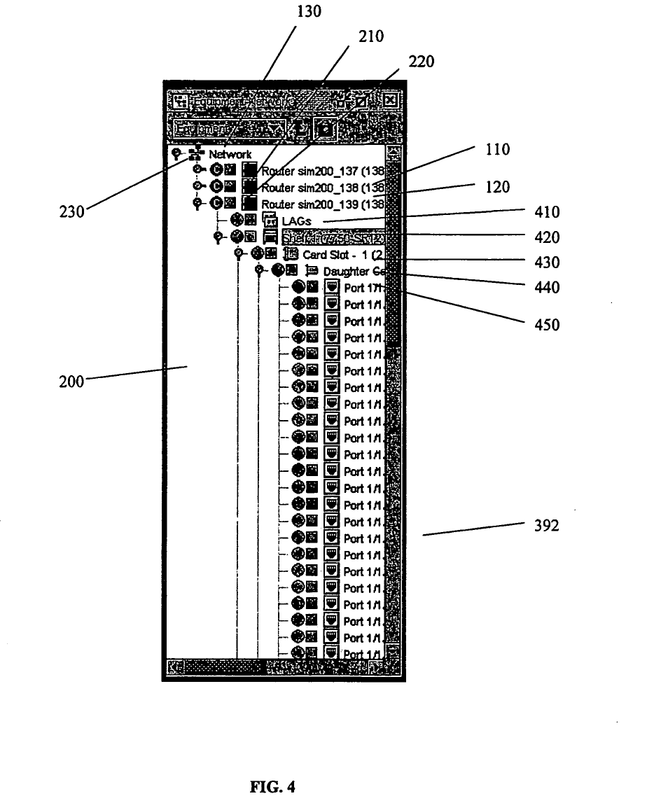

FIG. 4 is a screen capture illustrating the navigation tree 200 of FIG. 3 expanded for a network device 120 represented 220 in the tree 200. In FIG. 4, the network device 120 is a router which contains one or more link aggregation groups (“LAGs”) 410 and one or more shelves 420. Each shelf 420 contains one or more daughter cards 440 which contain one or more ports 450.

As mentioned above, one problem with current MNSs 300 is the inability of their graphical user interfaces (“GUIs”) 380 to effectively present the network devices 110, 120 comprising a communications network 100, 130 to users. This is especially so for communications networks 100, 130 that include high numbers (e.g., hundreds, thousands, etc.) of network devices 110, 120 such as routers, switches, etc. Typically, a NMS 300 displays network devices that it manages via a navigation tree display 200 such as that shown in FIG. 3. Such a navigation tree display 200, for example, may display up to 2000 network devices which may be organized into groups of 20-30 devices. Each device (e.g., 120) represented in the navigation tree display 200 may also be expanded (see FIG. 4) to display all the devices or items which they contain (e.g., shelves 420, card slots 430, daughter cards 440, ports 450, etc.). As such, the representation of the content of a single expanded network device 120 may take up most of the viewing area of the window 392 of the GUI 380 in which the expanded navigation tree 200 is displayed. This can result in extremely long trees even if the network 100, 130 has only 5-10 routers. In order to find or monitor a device (e.g., 120), the user or operator of the NMS 300 is required to frequently scroll to view all the devices of interest in the network 100, 130. If the user wants to view information pertaining to a different device (e.g., 110), the user must then scroll back up the hierarchy of the tree 200 and select the new device and expand it. This can be very time consuming. Thus, to view devices in large navigation trees 200 users must continuously expand and collapse device representations 210, 220 (or objects, items, containers, etc.) and/or scroll to desired locations within the tree 200. In particular, while users may wish to frequently monitor specific devices in the network, these devices are not all viewable at one time in the same tree display 200. In addition, while users may need to repeatedly access specific devices, searching through the device hierarchy in a navigation tree display 200 can be very time consuming especially when the tree display contains thousands of devices.

The present invention provides for the effective monitoring and accessing of network devices 110, 120 represented 210, 220 in large navigation trees 200 presented by a NMS 300. As will be described below, this is accomplished by allowing a user to customize navigation trees. In particular, the user can define the root for a new navigation tree which gives the user the ability to focus directly on any device or devices which they are interested in without having to scroll through the main or original navigation tree 200 for the network 100, 130. Thus, the user has the ability to change the root of the user's main or original tree 200 in the GUI 380 of the NMS 300 or can open multiple trees for viewing the required information.

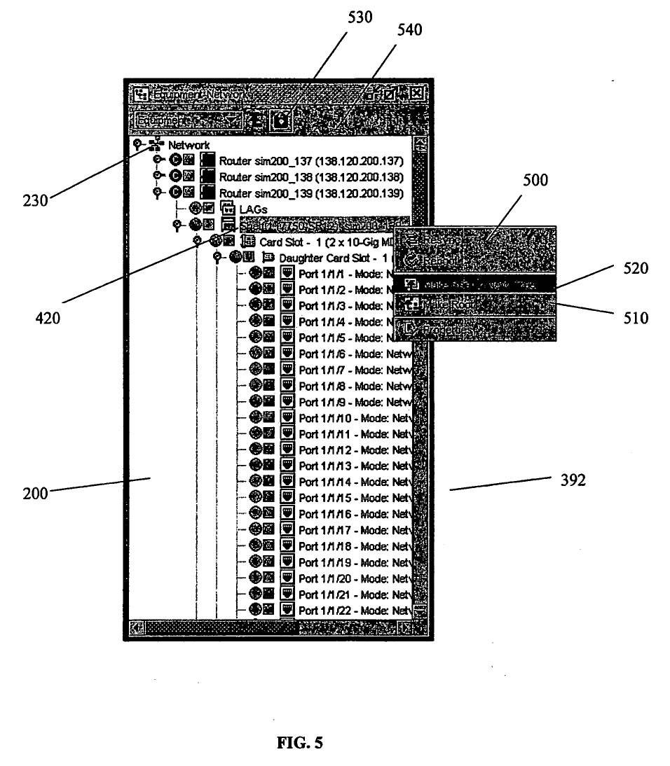

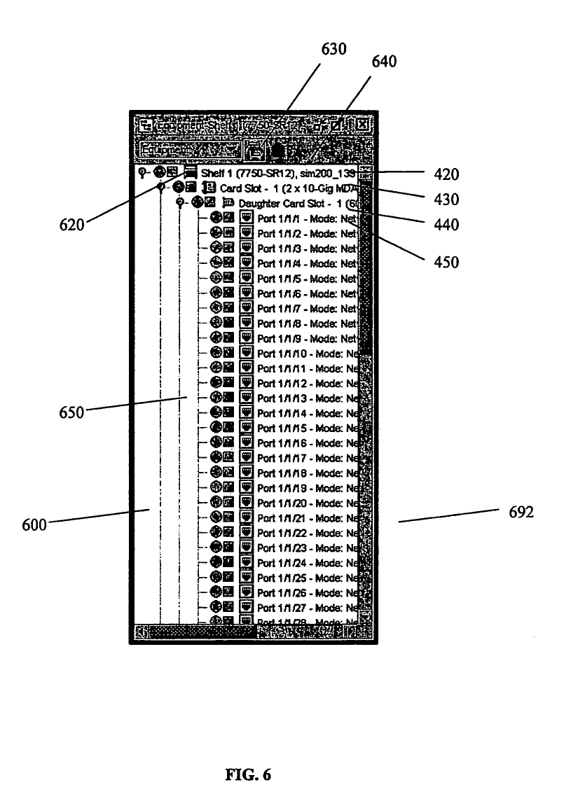

FIG. 5 is a screen capture illustrating a pop-up menu 500 for generating a new navigation tree (600 in FIG. 6) from an original navigation tree 200 in accordance with an embodiment of the invention. According to one embodiment, the pop-up menu 500 is presented when an object, device, or item (e.g., shelf 420) in the original navigation tree 200 is high-lighted (as shown in FIG. 5) and clicked. According to another embodiment, the pop-up menu 500 is presented when an object, device, or item (e.g., shelf 420) in the navigation tree is high-lighted (as shown in FIG. 5) and a new tree generation button 530 in a toolbar 540 of the window 392 is selected. The pop-up menu 500 includes a “Make Root” menu item 510 and a “Make Root in New Tree” menu item 520. The Make Root menu item 510 is for selecting by a user to initiate a Make Root function while the Make Root in New Tree menu item 510 is for selecting by a user to initiate a Make Root in New Tree function. As will be described below, the Make Root and the Make Root in New Tree functions enable the user to define what section of a tree 200 they would like to monitor or access, without having to scroll through the layers of the entire network 100, 130 represented by the original tree 200, and generate a new tree (600 in FIG. 6) for that section.

FIG. 6 is a screen capture illustrating a new navigation tree 600 in accordance with an embodiment of the invention. The Make Root function enables the user to select an object, device, or item (e.g., shelf 420) in the original navigation tree 200 and make it the root 620 of a new navigation tree 600. When a new root 620 is defined for a selected object, device, or item 420, only the contents 430, 440, 450 of that item 420 are listed 650 in the new navigation tree 600. If the user wishes to return to the new tree 600 to its original root 230, then a return button 630 presented in the toolbar 640 of the window 692 may be selected by the user.

If the user wishes to view multiple sections of the main or original tree 200, then the user may select the contextual Make Root in New Tree menu item 520 to initiate the Make Root in New Tree function. This function will open a new tree window 692 while leaving the existing tree window 392 open with the original root 230. The ability to have multiple tree windows 392, 692 open with different roots 230, 620 enables users to access and monitor several sections (e.g., for 120 and 420) of the network 100, 130 at the same time.

Thus, according to one embodiment, the user is provided with functions for hierarchically displaying navigation trees 200, 600 for networks 100, 130 through a GUI 380 of a NMS 300. These functions enable a user to select any object, device, or item (e.g., 420) in a navigation tree (e.g., 200), designate the selected object, device, or item 420 as a root (e.g., 620) for a new navigation tree (e.g., 600), and thereby generate a new navigation tree 600 that contains only the content (e.g., 430, 440, 450) of the selected object, device, or item 420 to be displayed via the GUI 380 of the NMS 300. This designated root 420, 620 may be revoked by the user whereupon the root for the navigation tree reverts back to the original root object, device, or item 130, 230 and the original navigation tree 200 is once again displayed to the user via the NMS's GUI 380.

The present invention provides several advantages. For example, it provides for improved user efficiency with respect to monitoring and managing frequently accessed objects, devices, or items 110, 120, 420 represented in a NMS 300. In particular, the Make Root and Make Root in New Tree functions provide enhanced productivity over existing NMS GUIs.

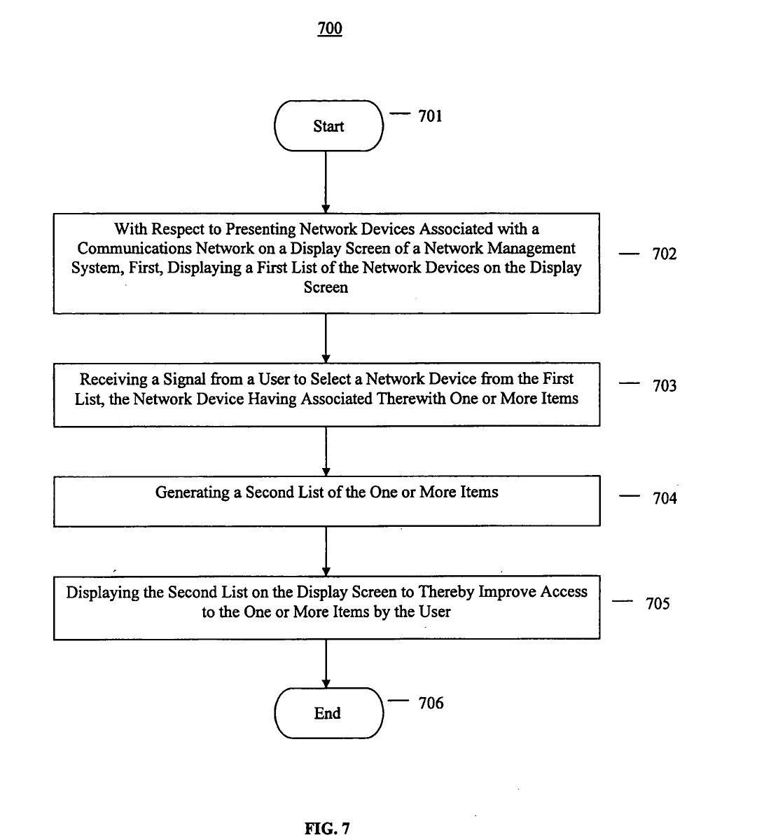

The above described method may be summarized with the aid of a flowchart. FIG. 7 is a flow chart illustrating operations 700 of modules 331 within the memory 330 of a data processing system (e.g., NMS 300) for presenting network devices (e.g., 110, 120, 420) associated with a communications network 100, 130 on a display screen 340 of the data processing system 300, in accordance with an embodiment of the invention.

At step 701, the operations 700 start.

At step 702, a first list 250 of the network devices 110, 120, 420 is displayed on the display screen 340.

At step 703, a signal is received from a user to select a network device (e.g., 420) from the first list 250, the network device 420 having associated therewith one or more items (or devices, objects, etc.) 430, 440, 450.

At step 704, a second list 650 of the one or more items 430, 440, 450 is generated.

At step 705, the second list 650 is displayed on the display screen 340 to thereby improve access to the one or more items 430, 440, 450 by the user.

At step 706, the operations 700 end.

The method may further include displaying the first and second lists 250, 650 as first and second navigation trees 200, 600, respectively. A first item in the first navigation tree 200 may be a first root 230 representing the communications network 130 and a first item in the second navigation tree 600 may be a second root 620 representing the network device 420. The method may further include displaying the first and second lists 250, 650 in first and second windows 392, 692, respectively. The method may further include receiving a signal 510 from the user to replace the first list 250 with the second list 650 on the display screen 340. The method may further include receiving a signal 630 from the user to replace the second list 650 with the first list 250 on the display screen 340. The method may further include receiving a signal 520 from the user to display both the first and second lists 250, 650 on the display screen 340. The network device 420 may be an item (or object, device, etc.) 430, 440, 450 within the network device 420. And, the one or more items 430, 440, 450 may be one or more of shelves, card slots, daughter cards, and ports.

While this invention is primarily discussed as a method, a person of ordinary skill in the art will understand that the apparatus discussed above with reference to a data processing system 300, may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment. This data carrier product can be loaded into and run by the data processing system 300. In addition, the sequences of instructions which when executed cause the method described herein to be performed by the data processing system 300 can be contained in a computer software product (e.g., software modules) according to one embodiment. This computer software product can be loaded into and run by the data processing system 300. Moreover, the sequences of instructions which when executed cause the method described herein to be performed by the data processing system 300 can be contained in an integrated circuit product (e.g., hardware modules) including a coprocessor or memory according to one embodiment. This integrated circuit product can be installed in the data processing system 300.

The embodiments of the invention described above are intended to be exemplary only. Those skilled in this art will understand that various modifications of detail may be made to these embodiments, all of which come within the scope of the invention.

What is claimed is:

1. A method for presenting network devices associated with a communications network on a display screen of a network management system, comprising:
displaying a first list of the network devices on the display screen;
receiving a signal from a user to select a network device from the first list, the network device having associated therewith one or more items;
generating a second list of the one or more items; and,
displaying the second list on the display screen to thereby improve access to the one or more items by the user.

2. The method of claim 1 and further comprising displaying the first and second lists as first and second navigation trees, respectively.

3. The method of claim 2 wherein a first item in the first navigation tree is a first root representing the communications network and wherein a first item in the second navigation tree is a second root representing the network device.

4. The method of claim 1 and further comprising displaying the first and second lists in first and second windows, respectively.

5. The method of claim 1 and further comprising receiving a signal from the user to replace the first list with the second list on the display screen.

6. The method of claim 1 and further comprising receiving a signal from the user to replace the second list with the first list on the display screen.

7. The method of claim 1 and further comprising receiving a signal from the user to display both the first and second lists on the display screen.

8. The method of claim 1 wherein the network device is an item within the network device.

9. The method of claim 8 wherein the one or more items are one or more of shelves, card slots, daughter cards, and ports.

10. A system for presenting network devices associated with a communications network on a display screen, comprising:
a processor coupled to memory, the display screen, and an input device; and,
modules within the memory and executed by the processor, the modules including:
a module for displaying a first list of the network devices on the display screen;
a module for receiving a signal from a user through the input device to select a network device from the first list, the network device having associated therewith one or more items;
a module for generating a second list of the one or more items; and,
a module for displaying the second list on the display screen to thereby improve access to the one or more items by the user.

11. The system of claim 10 and further comprising a module for displaying the first and second lists as first and second navigation trees, respectively.

12. The system of claim 11 wherein a first item in the first navigation tree is a first root representing the communications network and wherein a first item in the second navigation tree is a second root representing the network device.

13. The system of claim 10 and further comprising a module for displaying the first and second lists in first and second windows, respectively.

14. The system of claim 10 and further comprising a module for receiving a signal from the user to replace the first list with the second list on the display screen.

15. The system of claim 10 and further comprising a module for receiving a signal from the user to replace the second list with the first list on the display screen.

16. The system of claim 10 and further comprising a module for receiving a signal from the user to display both the first and second lists on the display screen.

17. The system of claim 10 wherein the network device is an item within the network device.

18. The system of claim 17 wherein the one or more items are one or more of shelves, card slots, daughter cards, and ports.
